(19) United States
(12) Patent Application Publication
(10) Pub. No.: US 2005/0093835 A1
(43) Pub. Date: May 5, 2005

(54) Finger Tip Stylus For Handheld Computing Devices

(76) Inventor: John Renato Mortarelli, Brimfield, MA (US)

Correspondence Address: JOHN RENATO MORTARELLI, 1529 DUNHAMTOWN - BRIMFIELD ROAD, BRIMFIELD, MA, 01010, US

(21) Appl. No.: 10/605,878

(22) Filed: Nov. 3, 2003

(51) Int. Cl. G09G 5/00

(52) U.S. Cl. 345/179

(57) ABSTRACT

A finger tip stylus for use in handheld computing devices is described which consists of a typical stylus tip supplemented with a contoured base that serves as a temporary, adhesive bonding interface between it and a finger tip or finger nail or both. By design the finger tip stylus is lightweight, low cost and not prone to loss or misplacement by the user. The stylus and/or the adhesive bonding surface may be implemented as single-use, disposable pointing device.

### BACKGROUND OF INVENTION

The small screen size of most handheld computing devices, PDA's for example, requires accurate input positioning information. Touching the display screen with just the finger tip for example, may not provide adequate information for proper performance of these devices when running certain types of software applications. For this reason most handheld computing devices are equipped with a “pencil-like” stylus intended to be held between the thumb and index finger to be used as a writing implement and/or as a user-interface, item-selection tool. The stylus tip is pointed in order to make precise positioning information available to the digitizer that subsequently encodes the stylus input. The stylus tip is constructed of a durable material, typically a hard plastic, which minimizes damage to the display surface. It is typically constructed as lightweight as possible.

While a typical “pencil-like” stylus solves the immediate problem of providing accurate input positioning information for a handheld computing device, it can be tiresome to use over a prolonged period of time, especially if the software application demands a continuous stream of fine motor inputs from the user, e.g., playing a video game such as “Solitaire” or typing large amounts of text on a soft keyboard for an extended length of time. Although hand writing is more natural, there is always the possibility of misplacing or loosing the stylus, even though a tube like pouch or cradle, which is part of the handheld device, is usually provided.

The typical “pencil-like” stylus also requires the user to alternately pick it up or put it down as needed in order to free the hand for other pending tasks, for example, answering a phone call, assuming the device is being held with the opposite hand.

The instant invention mitigates many of the issues associated with these types of pointing devices for handheld computing devices and improving upon their functionality.

### SUMMARY OF INVENTION

The invention consists of a typical “pencil-like” stylus tip supplemented with a contoured base support attached to a finger tip by some suitable temporary bonding adhesive in at least the four different ways described below. The instant invention is referred to here simply as a fingertip stylus. A finger tip stylus may be implemented as a disposable, single-use product or as a reusable product with a disposable, single-use, temporary adhesive bonding interface and may be applied to as many finger tips of the hand as is necessary to complete some desired task. For example, attaching a finger tip stylus to the index finger tip and another to the adjacent finger tip can provide for “two-finger” touch typing on a soft keyboard, while attaching a finger tip stylus to the index finger and pressing the thumb up against the index finger in typical handwriting fashion can serve well as a writing implement.

(1) The finger tip stylus can be attached to the finger tip by forming a temporary adhesive bond between the finger tip and the inside of the contoured base support. See Figure 1, version 1.

(2) The finger tip stylus can be attached to the finger tip by forming a temporary adhesive bond between the finger tip and the outside of the contoured base support by means of a circular adhesive patch, somewhat like a circular band aid, which bonds the outside of the contoured base support as well as part of the finger tip. See FIG. 1, version 2.

(3) The finger tip stylus can be attached to the finger tip by forming a temporary adhesive bond between part of the finger nail and the inside of an extension of the contoured base support. See FIG. 1, version 3.

(4) The finger tip stylus can be attached to the finger tip by forming a temporary adhesive bond between all of the finger nail and the inside of an extension of the contoured base support. See FIG. 1, version 4.

### BRIEF DESCRIPTION OF DRAWINGS

FIG. 1 comprises a collection of four (4) drawings intended to depict some of the various ways (versions 1-4) by which the finger tip stylus might interface with the finger tip.

### DETAILED DESCRIPTION

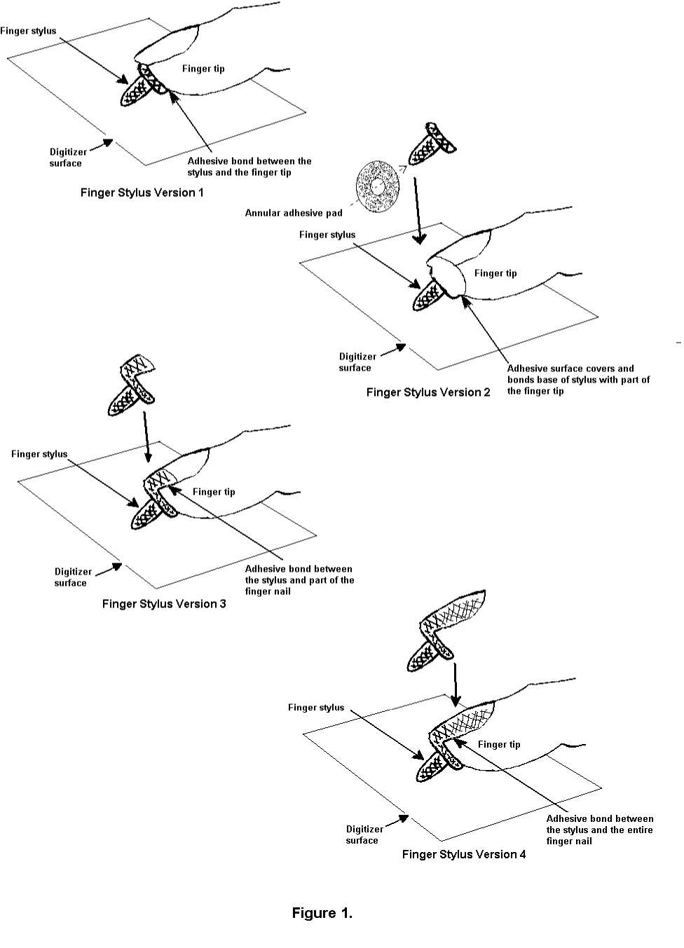

The instant invention consists of a typical “pencil-like” stylus tip supplemented with a contoured base support that attaches to a finger tip by some suitable temporary bonding adhesive either directly to the finger tip or indirectly to the finger nail or both. The stylus tip is constructed of a suitable durable material, typically a hard plastic, designed to minimize possible damage to the display surface. It is typically 10 millimeters in length and approximately 5 millimeters in diameter at its widest part and supplemented by a contoured base support most likely fabricated of identical material as the stylus tip itself and continuous with it, similar in size and shape to a hard contact lens of approximately 10 millimeters in diameter and a few millimeters thick. The contoured base support may be extended as necessary for attachment to part or all of a finger nail and the adhesive bonding surface may extend as well from underneath the finger nail to include part or all of the finger tip. The four basic methods of attachment are depicted in FIG. 1 versions 1-4.

1. The instant invention consists of the tip of a typical “pencil-like” stylus used as an input device for handheld computing devices continuous with and supplemented by a contoured base support designed to provide an adhesive bonding interface for either a finger tip or a finger nail. The stylus tip, which is constructed of a suitable durable material, typically a hard plastic, is designed to minimize possible damage to the display surface. It is typically 10 millimeters in length and approximately 5 millimeters in diameter at its widest part where upon it is supplemented by a contoured base support, similar in size and shape to a hard contact lens of approximately 10 millimeters in diameter and a few millimeters thick, when attached directly to part or all of a finger tip. When designed to attached to a finger nail the stylus tip is supplemented with more base support as necessary to interface with part or all of a finger nail consistent with the intended implementation.

2. The instant invention can be implemented in at least four versions as depicted in Figure 1. In addition, the adhesive bond of a finger stylus when designed to be attached to a finger nail as depicted in Figure 1 version 3 and version 4 can be extended down to include the finger tip as well and is implementation-dependent.

3. The finger tip stylus may temporarily be bonded directly to the finger tip by some suitable adhesive applied by the user or previously applied during production to the inside of the contoured base support as depicted in Figure 1 version 1. The finger tip stylus may be implemented as a single-use, disposable product or as a reusable product with a disposable, single-use adhesive interface.

4. The finger tip stylus may temporarily be bonded indirectly by some suitable annular, adhesive pad applied by the user or previously applied during production to the outside of the contoured base support as depicted in FIG. 1 version 2. The finger tip stylus may be implemented as a single-use, disposable product or as a reusable product with a disposable, single-use adhesive interface.

5. The finger tip stylus may temporarily be bonded directly to part or all of the finger nail by some suitable adhesive applied by the user or previously applied during production to the inside of the contoured base support as depicted in FIG. 1 version 3 and version 4. The finger tip stylus may be implemented as a single-use, disposable product or as a reusable product with a disposable, single-use adhesive interface.

6. The finger tip stylus by design is light weight, less tiresome to use over prolonged periods of time, especially when interfacing with software applications that demand a continuous stream of fine motor user inputs. It is less cumbersome than a finger stylus which surrounds or partly surrounds a finger mechanically using frictional forces or a handheld “pencil-like” stylus typically used with handheld computing devices.

7. The finger tip stylus by design is not easily lost or misplaced and does not need to be cradled in the handheld device. It enhances user efficiency by allowing essentially full use of the hand on which it is attached to accomplish other tasks. Compared to a typical “pencil-like” stylus, it additionally frees the user from alternately picking up or putting down the device to accomplish other pending tasks. It is by design at least as lightweight and as comfortable to wear as a finger tip stylus that surrounds or partly surrounds the finger and is mechanically attached to the finger tip by frictional forces.

8. The instant invention can serve as a user-interface, item-selection tool by providing accurate input positioning information, as a writing implement by pressing the thumb up against the index finger in typical handwriting fashion with a finger stylus attached to the index finger and can provide for two finger “touch typing” on the soft keyboard of a handheld device by attaching one finger tip stylus to the index finger and another to the adjacent finger.
